(19) United States
(12) Patent Application Publication
(10) Pub. No.: US 2026/0030079 A1
(43) Pub. Date: Jan. 29, 2026

(54) In-Browser Container Execution of High Latency Web Application Microservices to Decrease Latency

(71) Applicant: International Business Machines Corporation, Armonk, NY (US)

(72) Inventors: Paritosh Ranjan, Kolkata (IN); Prodip Roy, Kolkata (IN); Bhubaneswar Padhan, Kolkata (IN); Swarup Kumar Sikder, Kolkata (IN)

(21) Appl. No.: 18/782,226

(22) Filed: Jul. 24, 2024

(51) Int. Cl. G06F 9/54

(52) U.S. Cl. CPC G06F 9/547

(57) ABSTRACT

Decreasing latency of high latency microservices is provided. A Hypertext Transfer Protocol (HTTP) request is sent to an in-browser microservice running in an in-browser container of an in-browser container execution engine within a web browser of the host device to process the HTTP request. The HTTP request is processed using the in-browser microservice running in the in-browser container of the in-browser container execution engine within the web browser to decrease latency of the in-browser microservice that is marked as a high latency microservice. An HTTP response to the HTTP request is returned to the web browser based on the in-browser microservice running in the in-browser container of the in-browser container execution engine within the web browser processing the HTTP request.

### BACKGROUND

The disclosure relates generally to network latency and more specifically to high latency web application microservices.

Network latency is the time taken for data to travel from one point to another via a network. Data travels at the speed of light. However, due to external circumstances, such as, for example, physical distance, bandwidth limitations, too many connected devices, bad weather, poor network infrastructure, network misconfigurations, infrastructure malfunctions, and the like, there will be an increase in the amount of time it takes for data to travel in the network. This delay is known as network latency. Typically, network latency is measured in milliseconds, and the closer network latency is to zero, the better.

### SUMMARY

According to one illustrative embodiment, a computer-implemented method for decreasing latency of high latency microservices is provided. A host device sends a Hypertext Transfer Protocol (HTTP) request to an in-browser microservice running in an in-browser container of an in-browser container execution engine within a web browser of the host device to process the HTTP request. The host device processes the HTTP request using the in-browser microservice running in the in-browser container of the in-browser container execution engine within the web browser to decrease latency of the in-browser microservice that is marked as a high latency microservice. The host device returns an HTTP response to the HTTP request to the web browser based on the in-browser microservice running in the in-browser container of the in-browser container execution engine within the web browser processing the HTTP request. According to other illustrative embodiments, a computer system and computer program product for decreasing latency of high latency microservices are provided.

### BRIEF DESCRIPTION OF THE DRAWINGS

FIG. 1 is a pictorial representation of a computing environment in which illustrative embodiments may be implemented;

FIG. 2 is a diagram illustrating an example of a high latency microservice management system in accordance with an illustrative embodiment; and

FIGS. 3A-3C are a flowchart illustrating a process for decreasing latency of high latency microservices in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

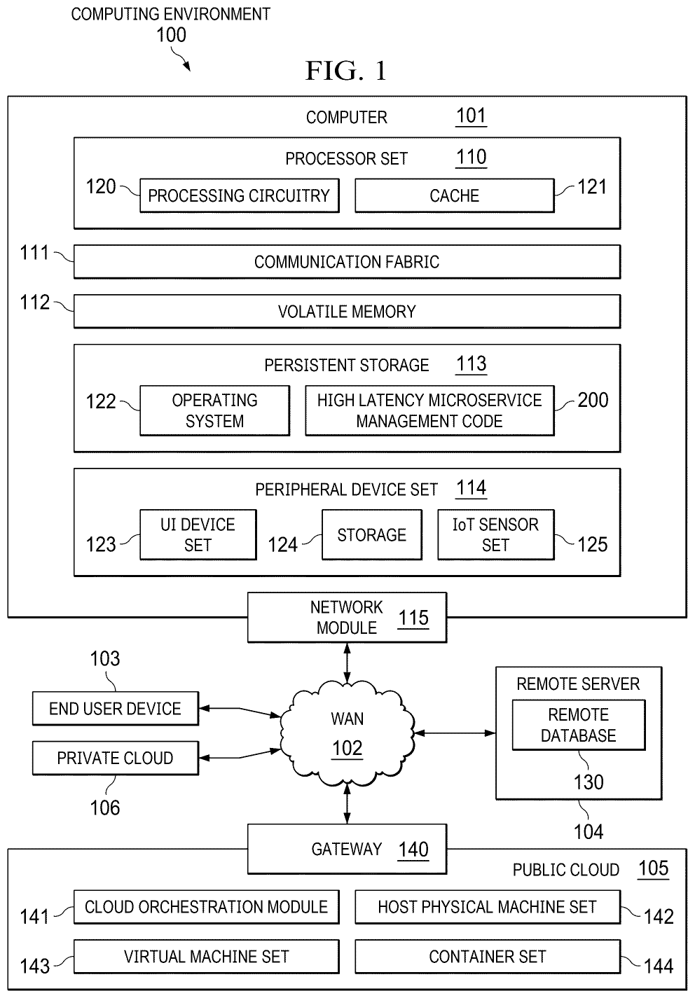

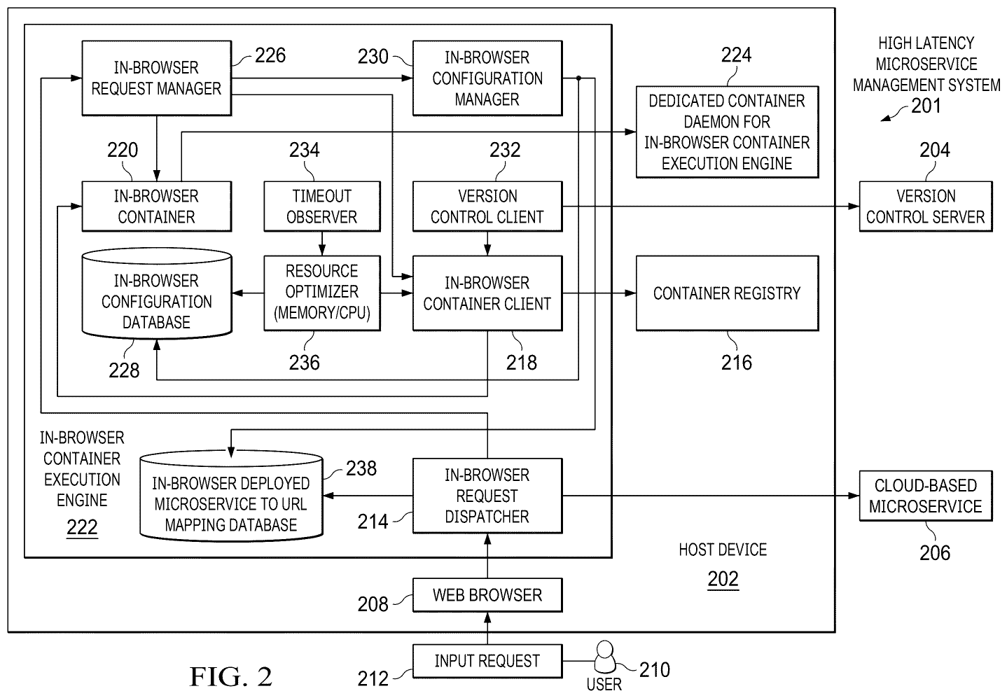

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of a container-based environment for the execution of at least some of the computer code involved in performing the inventive methods of illustrative embodiments, such as high latency microservice management code 200.

For example, high latency microservice management code 200 utilizes a container within a web browser to execute high latency web application microservices to decrease latency. High latency microservice management code 200 provisions a container runtime environment within the web browser. In addition, high latency microservice management code 200 shares container image metadata of containers executing the high latency web application microservices using HTTP response status codes and HTTP headers. High latency microservice management code 200 utilizes the web browser to extract the container image metadata of the containers executing the high latency web application microservices from the HTTP response metadata response status codes and HTTP headers and then downloads the containers. Afterward, high latency microservice management code 200 deploys the downloaded containers in an in-browser container execution engine of the web browser. High latency microservice management code 200 then forwards requests for the high latency microservices of the web application to the in-browser containers, which provide the high latency microservices, deployed in the in-browser container execution engine. High latency microservice management code 200 forwards all other requests for low latency microservices of the web application to containers deployed in a cloud, internet, or network environment.

Furthermore, high latency microservice management code 200 can chain an in-browser container to one or more other in-browser containers, as well as one or more cloud-based containers, to provide all the microservices corresponding to the web application. Further, high latency microservice management code 200 provides version upgrade and rollback of the in-browser containers as needed. Moreover, high latency microservice management code 200 deletes in-browser containers that timeout after expiration of a defined timeout value. Also, high latency microservice management code 200 optimizes processor and memory resource utilization of the in-browser containers based on, for example, defined rules and a maximum resource utilization threshold level.

In addition to high latency microservice management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and high latency microservice management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, smart television, smart phone, smart watch or other wearable computer, or any other form of computer or mobile device now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in high latency microservice management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a program developer an entity that operates computer 101), and may take any of the forms discussed above in connection with computer 101. EUD 103 typically receives helpful and useful data from the operations of computer 101. For example, in a hypothetical case where computer 101 is designed to provide a high latency microservice management recommendation to the end user, this recommendation would typically be communicated from network module 115 of computer 101 through WAN 102 to EUD 103. In this way, EUD 103 can display, or otherwise present, the high latency microservice management recommendation to the end user. In some embodiments, EUD 103 may be a client device, such as a thin client, heavy client, mainframe computer, desktop computer, laptop computer, tablet computer, smart phone, smart watch, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a high latency microservice management recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Ideally, there should be no network latency. However, this is not technically possible in the real-world, but there is still a need to decrease network latency as much as possible to increase user experience. Illustrative embodiments perform in-browser container execution of high latency web application microservices to achieve overall lower latency in the web application.

The shift away from monolithic application development began with the service-oriented architecture, which consists of a collection of services that communicate with one another within a system. The next progression was the microservice architecture, which evolved to offer a more cohesive, but still granular, approach to application development, and has been gaining popularity with large-scale enterprises.

Dividing a web application into smaller autonomous segments makes it easier to build and maintain the web application. In addition, each microservice corresponding to an autonomous fragment of the web application can be developed, deployed, and managed independently.

A web browser connects to the gateway of the microservices corresponding to the web application. For example, assume a front facing microservice component (e.g., an Angular-based microservice) of the web application is hosted in a container. This front facing user interface gateway microservice displays the user interface to a user. As a result, the user interface gateway microservice needs to stream all the images being used in the user interface. Streaming all the images being used in the user interface takes time, which increases latency.

Once the user interface gateway microservice receives a user request, the user interface gateway microservice forwards the user request to other containers hosting representational state transfer (REST) APIs to process the data and store the data in a database. The web application-based container hosting the user interface gateway microservice consumes a large amount of time as the user interface gateway microservice has to stream all the images needed for all of the pages of the user interface. As a result, the user interface gateway microservice is responsible for increased latency of the web application. For example, the data processing and database-related microservices corresponding to the web application consume less time and have a negligible contribution to the overall latency of the web application than the user interface gateway microservice. Consequently, illustrative embodiments mark the user interface gateway microservice as a high latency component of the web application. Therefore, illustrative embodiments execute the user interface gateway microservice locally in an in-browser container execution engine in order to decrease latency of the user interface gateway microservice and the overall latency of the web application.

The web browser contains the in-browser container execution engine to execute the in-browser containers providing the high latency microservices of the web application. The web browser downloads a container image of a container, which corresponds to a microservice declared by an API owner as a high latency web application component, into the in-browser container execution engine. The web browser executes these high latency microservice components locally in the in-browser container execution engine using the in-browser containers. The web application connects to the local deployments of the high latency microservices, which the web browser downloaded into the in-browser container execution engine locally, either directly or via another microservice.

Illustrative embodiments respond with a unique Hypertext Transfer Protocol (HTTP) status code with HTTP response header metadata containing a Uniform Resource Locator (URL) of the container image corresponding to the container. The web browser interprets the unique HTTP status code with HTTP response header metadata containing the URL of the container image of the container. The web browser extracts the container image URL and then deploys the container image in the in-browser container execution engine. The web browser makes the in-browser microservice execution engine aware of the deployment of the high latency microservice in the in-browser container once start of the in-browser container is successful. The web browser then sends any requests for the high latency microservice to the in-browser container execution engine. Sending requests for the high latency microservice to the in-browser container execution engine reduces the latency of the high latency microservice, and this, in turn, reduces the overall latency of the web application The in-browser container execution engine hosting the high latency microservice forwards all other requests for low latency microservices of the web application to corresponding containers deployed in the cloud, internet, or network.

Illustrative embodiments can chain multiple containers together. For example, if the in-browser container execution engine executes more than one in-browser container corresponding to high latency microservices in the web browser, then the high latency microservices deployed in the in-browser containers would have microservice dependency information embedded in them beforehand whether the high latency microservices would be interacting with another in-browser high latency microservice or a cloud-based low latency microservice corresponding to the web application. As a result, one in-browser container corresponding to a high latency microservice can connect to another in-browser container corresponding to another high latency microservice via a localhost URL and can connect to a cloud-based microservice via a cloud URL. The rest of the path of the URL would be the unique path of the microservice. It should be noted that illustrative embodiments can chain as many containers together as needed.

In addition, illustrative embodiments perform version upgrades of in-browser containers corresponding to high latency microservices. For example, illustrative embodiments utilize a version control server in the cloud to obtain the version upgrades of the in-browser containers corresponding to high latency microservices. Illustrative embodiments check the version control server for availability of newer versions of container images on a time interval basis, such as, for example, every hour, six hours, twelve hours, day, week, month, or any other increment of time. If illustrative embodiments determine that a newer version of a container image is available, then illustrative embodiments download the newer version of the container image in the in-browser container execution engine.

Further, illustrative embodiments can roll back an in-browser container to a previous version. For example, illustrative embodiments utilize the version control server in the cloud to obtain the previous version of the in-browser container to roll back the in-browser container to the previous version after the in-browser container was upgraded to a newer version of the in-browser container. Illustrative embodiments utilize a version control client of the in-browser container execution engine to request the next version of the in-browser container, if any, from the version control server in the cloud. For rollback purposes, the version control server provides the previous version of the container image as the next version to the version control client. The version control client utilizes an in-browser container client to install the previous version of the container for the roll back. Consequently, the in-browser container client implements the rollback by installing the previous version of the in-browser container again. It should be noted that the in-browser container client stores the previous version of the container image in a container registry. The container registry can be located either locally in the web browser or remotely in the cloud.

Furthermore, illustrative embodiments optimize resource utilization in the host device. For example, illustrative embodiments can deploy in-browser containers in the in-browser container execution engine with a timeout value. The timeout value can be, for example, a default timeout value, a user-defined timeout value, a system-defined timeout value, or the like. The in-browser container execution engine deletes an in-browser container, which includes a timeout value, after the in-browser container times out. The in-browser container execution engine will not delete an in-browser container that does not have a timeout value.

Moreover, illustrative embodiments can deploy in-browser containers marked, for example, by default, user, or system, as deletable or non-deletable. The in-browser container execution engine deletes in-browser containers marked as deletable to create space for other in-browser containers or to make available host device resources as needed. Illustrative embodiments can redeploy these deleted in-browser containers marked as deletable if needed later. Illustrative embodiments will not delete an in-browser container marked as non-deletable until the in-browser container marked as non-deletable times out.

Further, illustrative embodiments utilize a maximum resource utilization threshold level of the host device. The host device resources include, for example, processor, memory, storage, network components, and the like. A user configures the in-browser container execution engine to utilize less than the maximum utilization threshold level for at least one of the processor and memory on the host device. For example, if running a new in-browser container will exceed the maximum resource utilization threshold level of the in-browser container execution engine, then the in-browser container execution engine will delete a set of currently deployed in-browser containers as per defined rules until needed host device resources, such as, for example, memory and processor, become available for the new in-browser container. The predefined rules can include, for example, delete the oldest deletable in-browser container first, delete least utilized deletable in-browser containers by rank, and the like. Illustrative embodiments can rank deletable in-browser containers utilizing, for example, the following: container rank is equal to (number of requests serviced by a container) divided by (age of the container multiplied by size of the container).

The user can also configure the in-browser container execution engine to not utilize in-browser microservice execution when resource utilization on the host device is greater than or equal to the maximum resource utilization threshold level, and instead utilize cloud-based microservice execution. This kind of fault tolerance makes the host device more resilient.

Thus, illustrative embodiments provide one or more technical solutions that overcome a technical problem with high latency microservices corresponding to web applications causing increased network latency. As a result, these one or more technical solutions provide a technical effect and practical application in the field of network latency.

With reference now to FIG. 2, a diagram illustrating an example of a high latency microservice management system is depicted in accordance with an illustrative embodiment. High latency microservice management system 201 may be implemented in a computing environment, such as computing environment 100 in FIG. 1. High latency microservice management system 201 is a system of hardware and software components for decreasing latency of high latency microservices corresponding to web applications to increase user experience.

In this example, high latency microservice management system 201 includes host device 202, version control server 204, and cloud-based microservice 206. Host device 202 can be, for example, computer 101 in FIG. 1. Version control server 204 can be, for example, remote server 104 in FIG. 1. Cloud-based microservice 206 can be running on, for example, one of host physical machine set 142, virtual machine set 143, or container set 144 in FIG. 1. However, it should be noted that high latency microservice management system 201 is intended as an example only and not as a limitation on illustrative embodiments. For example, high latency microservice management system 201 can include any number of host devices, version control servers, cloud-based microservices, and other devices and components not shown.

Host device 202 represents any device, such as, for example, a mainframe computer, desktop computer, laptop computer, handheld computer, smart phone, smart television, or the like, where a web browser, such as web browser 208, is installed and used by a user, such as user 210. Web browser 208 can represent any type of web browser capable of implementing illustrative embodiments.

Input request 212 represents any HTTP request made by user 210 opening a URL in web browser 208. Web browser 208 utilizes in-browser request dispatcher 214 to route HTTP requests, such as input request 212, between an in-browser microservice or a cloud-based microservice based on the HTTP header metadata included in a particular HTTP request. Cloud-based microservice 206 represents the microservice version deployed on the cloud, internet, or network, which in-browser request dispatcher 214 will call when the in-browser microservice version is not available or deployable for any reason.

Container registry 216 represents an in-browser container registry used to store container images, which in-browser container client 218 deploys in in-browser container 220. However, it should be noted that even though container registry 216 is located locally on host device 202 in this example, container registry 216 can be located remotely in the cloud, internet, or network in an alternative illustrative embodiment. Version control server 204 provides information regarding availability of new versions of in-browser microservices deployed in in-browser containers and provides the metadata (e.g., container image URLs and other configuration information) of the new versions of the in-browser microservices, which can be upgraded in in-browser container execution engine 222.

Dedicated container daemon 224 for in-browser container execution engine 222 provides the dedicated container runtime for web browser 208 on host device 202. In-browser container execution engine 222 provides the whole in-browser microservice ecosystem for executing high latency microservices of the web application. In-browser request manager 226 manages incoming requests to in-browser container execution engine 222 and interacts with the other components of in-browser container execution engine 222.

In-browser container 220 represents a container, which hosts a high latency microservice, executing in dedicated container daemon 224 for in-browser container execution engine 222. It should be noted that in-browser container 220 can represent a plurality of different in-browser containers corresponding to a plurality of different high latency microservices associated with a plurality of different web applications.

In-browser configuration database 228 stores configuration information corresponding to the in-browser microservices deployed in the in-browser containers. In-browser configuration manager 230 reads and writes the in-browser configuration information regarding the deployed in-browser microservices stored in in-browser configuration database 228.

Version control client 232 manages versions of the in-browser containers corresponding to the high latency microservices deployed within in-browser container execution engine 222. Timeout observer 234 deletes eligible in-browser containers providing the high latency microservices after expiration of a configured time interval. In-browser container client 218 deploys and un-deploys the in-browser containers providing the high latency microservices.

Resource optimizer 236 optimizes utilization of resources, such as memory, processor, storage, and the like, of host device 202 allocated to in-browser container execution engine 222. In-browser deployed microservices to URL mapping database 238 contains a mapping between URLs of deployed in-browser microservices and the availability of the deployed in-browser microservice for the URLs of the deployed in-browser microservices.

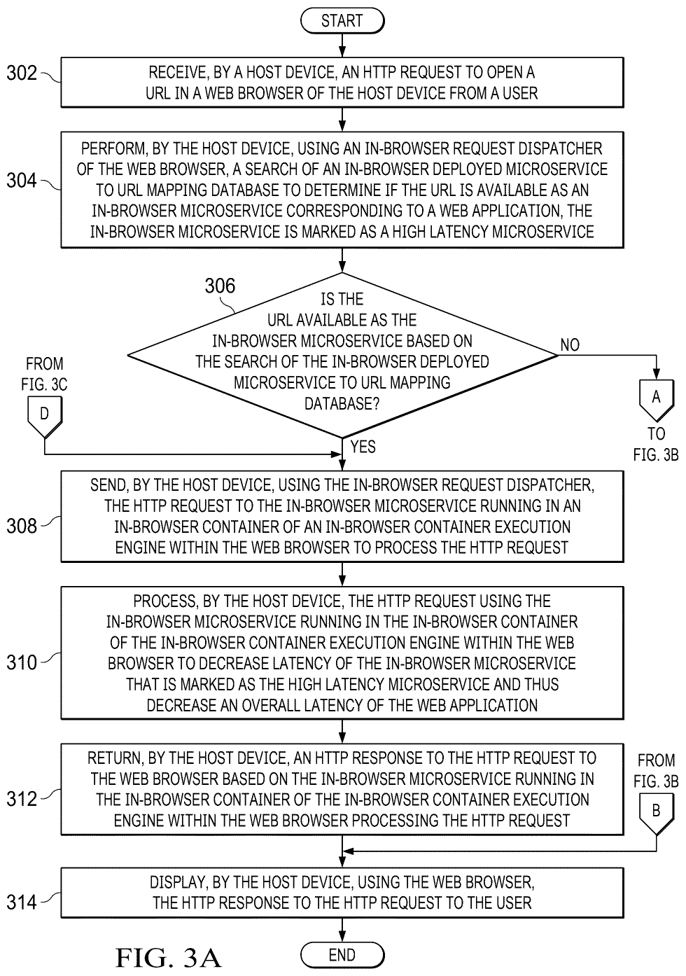

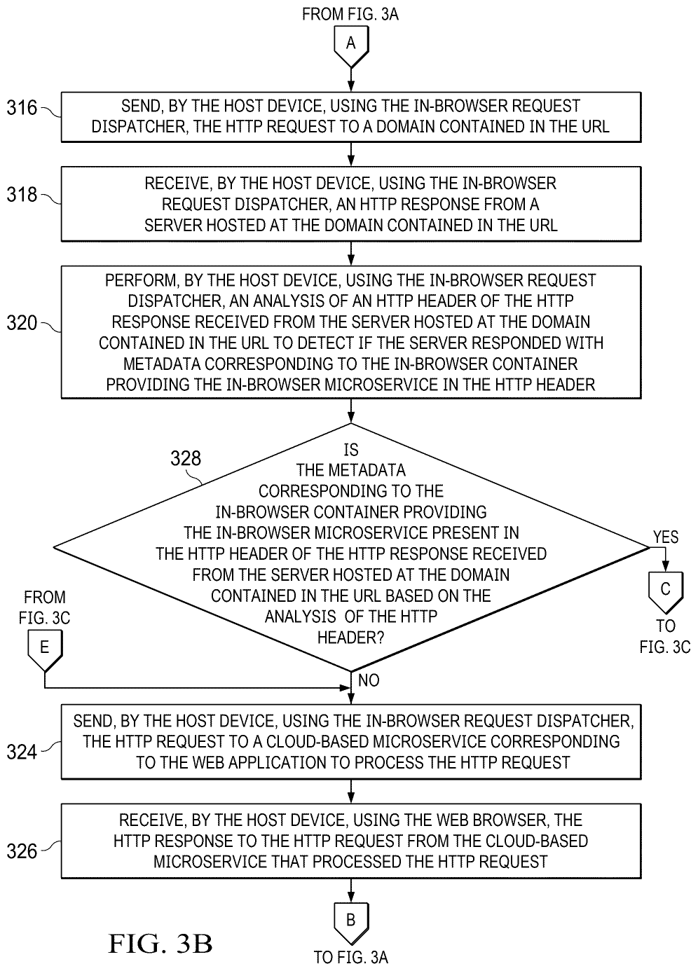

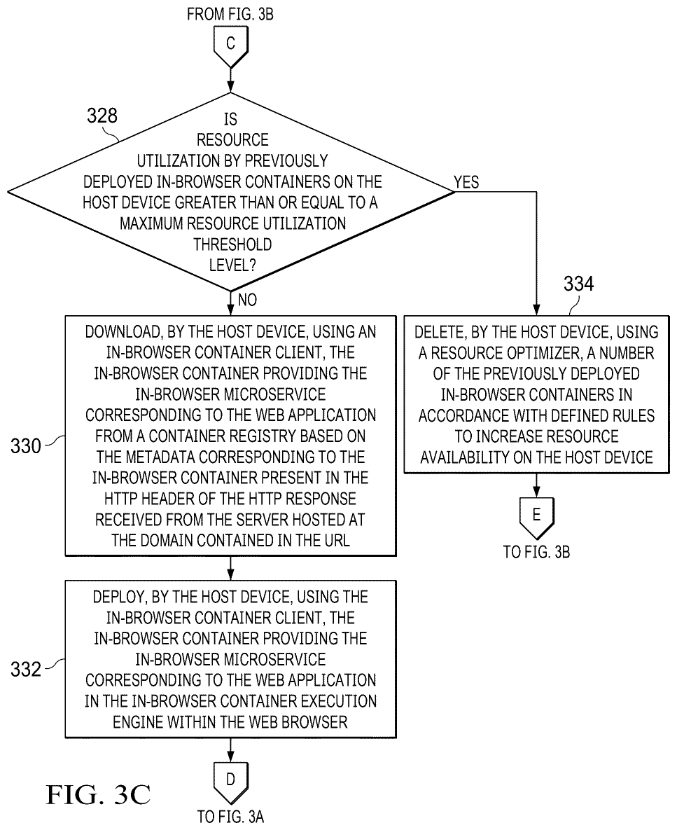

With reference now to FIGS. 3A-3C, a flowchart illustrating a process for decreasing latency of high latency microservices is shown in accordance with an illustrative embodiment. The process shown in FIGS. 3A-3C may be implemented in a host device, such as, for example, computer 101 in FIG. 1 or host device 202 in FIG. 2. For example, the process shown in FIGS. 3A-3C may be implemented by high latency microservice management code 200 in FIG. 1.

The process begins when the host device receives an HTTP request to open a URL in a web browser of the host device from a user (step 302). In response to receiving the HTTP request, the host device, using an in-browser request dispatcher of the web browser, performs a search of an in-browser deployed microservice to URL mapping database to determine if the URL is available as an in-browser microservice corresponding to a web application (step 304). The in-browser microservice is marked as a high latency microservice.

The host device, using the in-browser request dispatcher, makes a determination as to whether the URL is available as the in-browser microservice based on the search of the in-browser deployed microservice to URL mapping database (step 306). If the host device, using the in-browser request dispatcher, determines that the URL is available as the in-browser microservice based on the search of the in-browser deployed microservice to URL mapping database, yes output of step 306, then the host device, using the in-browser request dispatcher, sends the HTTP request to the in-browser microservice running in an in-browser container of an in-browser container execution engine within the web browser to process the HTTP request (step 308). The host device processes the HTTP request using the in-browser microservice running in the in-browser container of the in-browser container execution engine within the web browser to decrease latency of the in-browser microservice that is marked as the high latency microservice and thus decrease an overall latency of the web application (step 310).

The host device returns an HTTP response to the HTTP request to the web browser based on the in-browser microservice running in the in-browser container of the in-browser container execution engine within the web browser processing the HTTP request (step 312). The host device, using the web browser, displays the HTTP response to the HTTP request to the user (step 314). Thereafter, the process terminates.

Returning again to step 306, if the host device, using the in-browser request dispatcher, determines that the URL is not available as the in-browser microservice based on the search of the in-browser deployed microservice to URL mapping database, no output of step 306, then the host device, using the in-browser request dispatcher, sends the HTTP request to a domain contained in the URL (step 316). Subsequently, the host device, using the in-browser request dispatcher, receives an HTTP response from a server hosted at the domain contained in the URL (step 318). The host device, using the in-browser request dispatcher, performs an analysis of an HTTP header of the HTTP response received from the server hosted at the domain contained in the URL to detect if the server responded with metadata corresponding to the in-browser container providing the in-browser microservice in the HTTP header (step 320).

The host device, using the in-browser request dispatcher, makes a determination as to whether the metadata corresponding to the in-browser container providing the in-browser microservice is present in the HTTP header of the HTTP response received from the server hosted at the domain contained in the URL based on the analysis of the HTTP header (step 322). If the host device, using the in-browser request dispatcher, determines that the metadata corresponding to the in-browser container providing the in-browser microservice is not present in the HTTP header of the HTTP response received from the server hosted at the domain contained in the URL based on the analysis of the HTTP header, no output of step 322, then the host device, using the in-browser request dispatcher, sends the HTTP request to a cloud-based microservice corresponding to the web application to process the HTTP request (step 324). Afterward, the host device, using the web browser, receives the HTTP response to the HTTP request from the cloud-based microservice that processed the HTTP request (step 326). Thereafter, the process returns to step 314 where the host device, using the web browser, displays the HTTP response to the HTTP request to the user.

Returning again to step 322, if the host device, using the in-browser request dispatcher, determines that the metadata corresponding to the in-browser container providing the in-browser microservice is present in the HTTP header of the HTTP response received from the server hosted at the domain contained in the URL based on the analysis of the HTTP header, yes output of step 322, then the host device, using a resource optimizer, makes a determination as to whether resource utilization by previously deployed in-browser containers on the host device is greater than or equal to a maximum resource utilization threshold level (step 328). If the host device, using the resource optimizer, determines that the resource utilization by the previously deployed in-browser containers on the host device is not greater than or equal to the maximum resource utilization threshold level, no output of step 328, then the host device, using an in-browser container client, downloads the in-browser container providing the in-browser microservice corresponding to the web application from a container registry based on the metadata corresponding to the in-browser container present in the HTTP header of the HTTP response received from the server hosted at the domain contained in the URL (step 330). The host device, using the in-browser container client, then deploys the in-browser container providing the in-browser microservice corresponding to the web application in the in-browser container execution engine within the web browser (step 332). Thereafter, the process returns to step 308 where the host device, using the in-browser request dispatcher, sends the HTTP request to the in-browser microservice to process the HTTP request.

Returning again to step 328, if the host device, using the resource optimizer, determines that the resource utilization by the previously deployed in-browser containers on the host device is greater than or equal to the maximum resource utilization threshold level, yes output of step 328, then the host device, using the resource optimizer, deletes a number of the previously deployed in-browser containers in accordance with defined rules to increase resource availability on the host device (step 334). Thereafter, the process returns to step 324 where the host device, using the in-browser request dispatcher, sends the HTTP request to the cloud-based microservice for processing.

Thus, illustrative embodiments of the present disclosure provide a computer-implemented method, computer system, and computer program product for managing high latency microservices. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for decreasing latency of high latency microservices, the computer-implemented method comprising:
sending, by a host device, a Hypertext Transfer Protocol (HTTP) request to an in-browser microservice running in an in-browser container of an in-browser container execution engine within a web browser of the host device to process the HTTP request;
processing, by the host device, the HTTP request using the in-browser microservice running in the in-browser container of the in-browser container execution engine within the web browser to decrease latency of the in-browser microservice that is marked as a high latency microservice; and
returning, by the host device, an HTTP response to the HTTP request to the web browser based on the in-browser microservice running in the in-browser container of the in-browser container execution engine within the web browser processing the HTTP request.

2. The computer-implemented method of claim 1, further comprising:
receiving, by the host device, the HTTP request to open a Uniform Resource Locator (URL) in the web browser of the host device from a user;
performing, by the host device, a search of an in-browser deployed microservice to URL mapping database to determine if the URL is available as the in-browser microservice corresponding to a web application;
determining, by the host device, whether the URL is available as the in-browser microservice based on the search of the in-browser deployed microservice to URL mapping database; and
responsive to the host device determining that the URL is available as the in-browser microservice based on the search of the in-browser deployed microservice to URL mapping database, sending, by the host device, the HTTP request to the in-browser microservice running in the in-browser container of the in-browser container execution engine within the web browser to process the HTTP request.

3. The computer-implemented method of claim 2, further comprising:
responsive to the host device determining that the URL is not available as the in-browser microservice based on the search of the in-browser deployed microservice to URL mapping database, sending, by the host device, the HTTP request to a domain contained in the URL; and
receiving, by the host device, an HTTP response from a server hosted at the domain contained in the URL.

4. The computer-implemented method of claim 3, further comprising:
performing, by the host device, an analysis of an HTTP header of the HTTP response received from the server hosted at the domain contained in the URL to detect if the server responded with metadata corresponding to the in-browser container providing the in-browser microservice in the HTTP header; and
determining, by the host device, whether the metadata corresponding to the in-browser container providing the in-browser microservice is present in the HTTP header of the HTTP response received from the server hosted at the domain contained in the URL based on the analysis of the HTTP header.

5. The computer-implemented method of claim 4, further comprising:
responsive to the host device determining that the metadata corresponding to the in-browser container providing the in-browser microservice is not present in the HTTP header of the HTTP response received from the server hosted at the domain contained in the URL based on the analysis of the HTTP header, sending, by the host device, the HTTP request to a cloud-based microservice corresponding to the web application to process the HTTP request; and
receiving, by the host device, the HTTP response to the HTTP request from the cloud-based microservice that processed the HTTP request.

6. The computer-implemented method of claim 4, further comprising:
responsive to the host device determining that the metadata corresponding to the in-browser container providing the in-browser microservice is present in the HTTP header of the HTTP response received from the server hosted at the domain contained in the URL based on the analysis of the HTTP header, determining, by the host device, whether resource utilization by previously deployed in-browser containers on the host device is greater than or equal to a maximum resource utilization threshold level;
responsive to the host device determining that the resource utilization by the previously deployed in-browser containers on the host device is not greater than or equal to the maximum resource utilization threshold level, downloading, by the host device, the in-browser container providing the in-browser microservice corresponding to the web application from a container registry based on the metadata corresponding to the in-browser container present in the HTTP header of the HTTP response received from the server hosted at the domain contained in the URL; and
deploying, by the host device, the in-browser container providing the in-browser microservice corresponding to the web application in the in-browser container execution engine within the web browser.

7. The computer-implemented method of claim 6, further comprising:
responsive to the host device determining that the resource utilization by the previously deployed in-browser containers on the host device is greater than or equal to the maximum resource utilization threshold level, deleting, by the host device, a number of the previously deployed in-browser containers in accordance with defined rules to increase resource availability on the host device.

8. The computer-implemented method of claim 1, further comprising:
displaying, by the host device, the HTTP response to the HTTP request to a user using the web browser.

9. A computer system for decreasing latency of high latency microservices, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
send a Hypertext Transfer Protocol (HTTP) request to an in-browser microservice running in an in-browser container of an in-browser container execution engine within a web browser to process the HTTP request;
process the HTTP request using the in-browser microservice running in the in-browser container of the in-browser container execution engine within the web browser to decrease latency of the in-browser microservice that is marked as a high latency microservice; and
return an HTTP response to the HTTP request to the web browser based on the in-browser microservice running in the in-browser container of the in-browser container execution engine within the web browser processing the HTTP request.

10. The computer system of claim 9, wherein the set of processors further executes the program instructions to:
receive the HTTP request to open a Uniform Resource Locator (URL) in the web browser from a user;
perform a search of an in-browser deployed microservice to URL mapping database to determine if the URL is available as the in-browser microservice corresponding to a web application;
determine whether the URL is available as the in-browser microservice based on the search of the in-browser deployed microservice to URL mapping database; and
send the HTTP request to the in-browser microservice running in the in-browser container of the in-browser container execution engine within the web browser to process the HTTP request in response to determining that the URL is available as the in-browser microservice based on the search of the in-browser deployed microservice to URL mapping database.

11. The computer system of claim 10, wherein the set of processors further executes the program instructions to:
send the HTTP request to a domain contained in the URL in response to determining that the URL is not available as the in-browser microservice based on the search of the in-browser deployed microservice to URL mapping database; and
receive an HTTP response from a server hosted at the domain contained in the URL.

12. The computer system of claim 11, wherein the set of processors further executes the program instructions to:
perform an analysis of an HTTP header of the HTTP response received from the server hosted at the domain contained in the URL to detect if the server responded with metadata corresponding to the in-browser container providing the in-browser microservice in the HTTP header; and
determine whether the metadata corresponding to the in-browser container providing the in-browser microservice is present in the HTTP header of the HTTP response received from the server hosted at the domain contained in the URL based on the analysis of the HTTP header.

13. The computer system of claim 12, wherein the set of processors further executes the program instructions to:
send the HTTP request to a cloud-based microservice corresponding to the web application to process the HTTP request in response to determining that the metadata corresponding to the in-browser container providing the in-browser microservice is not present in the HTTP header of the HTTP response received from the server hosted at the domain contained in the URL based on the analysis of the HTTP header; and
receive the HTTP response to the HTTP request from the cloud-based microservice that processed the HTTP request.

14. The computer system of claim 12, wherein the set of processors further executes the program instructions to:
determine whether resource utilization by previously deployed in-browser containers is greater than or equal to a maximum resource utilization threshold level in response to determining that the metadata corresponding to the in-browser container providing the in-browser microservice is present in the HTTP header of the HTTP response received from the server hosted at the domain contained in the URL based on the analysis of the HTTP header;
download the in-browser container providing the in-browser microservice corresponding to the web application from a container registry based on the metadata corresponding to the in-browser container present in the HTTP header of the HTTP response received from the server hosted at the domain contained in the URL in response to determining that the resource utilization by the previously deployed in-browser containers is not greater than or equal to the maximum resource utilization threshold level; and
deploy the in-browser container providing the in-browser microservice corresponding to the web application in the in-browser container execution engine within the web browser.

15. A computer program product for decreasing latency of high latency microservices, the computer program product comprising a set of computer-readable storage media having program instructions collectively stored therein, the program instructions executable by a computer to cause the computer to:
send a Hypertext Transfer Protocol (HTTP) request to an in-browser microservice running in an in-browser container of an in-browser container execution engine within a web browser to process the HTTP request;
process the HTTP request using the in-browser microservice running in the in-browser container of the in-browser container execution engine within the web browser to decrease latency of the in-browser microservice that is marked as a high latency microservice; and
return an HTTP response to the HTTP request to the web browser based on the in-browser microservice running in the in-browser container of the in-browser container execution engine within the web browser processing the HTTP request.

16. The computer program product of claim 15, wherein the program instructions further cause the computer to:
receive the HTTP request to open a Uniform Resource Locator (URL) in the web browser from a user;
perform a search of an in-browser deployed microservice to URL mapping database to determine if the URL is available as the in-browser microservice corresponding to a web application;
determine whether the URL is available as the in-browser microservice based on the search of the in-browser deployed microservice to URL mapping database; and
send the HTTP request to the in-browser microservice running in the in-browser container of the in-browser container execution engine within the web browser to process the HTTP request in response to determining that the URL is available as the in-browser microservice based on the search of the in-browser deployed microservice to URL mapping database.

17. The computer program product of claim 16, wherein the program instructions further cause the computer to:
send the HTTP request to a domain contained in the URL in response to determining that the URL is not available as the in-browser microservice based on the search of the in-browser deployed microservice to URL mapping database; and
receive an HTTP response from a server hosted at the domain contained in the URL.

18. The computer program product of claim 17, wherein the program instructions further cause the computer to:
perform an analysis of an HTTP header of the HTTP response received from the server hosted at the domain contained in the URL to detect if the server responded with metadata corresponding to the in-browser container providing the in-browser microservice in the HTTP header; and
determine whether the metadata corresponding to the in-browser container providing the in-browser microservice is present in the HTTP header of the HTTP response received from the server hosted at the domain contained in the URL based on the analysis of the HTTP header.

19. The computer program product of claim 18, wherein the program instructions further cause the computer to:
send the HTTP request to a cloud-based microservice corresponding to the web application to process the HTTP request in response to determining that the metadata corresponding to the in-browser container providing the in-browser microservice is not present in the HTTP header of the HTTP response received from the server hosted at the domain contained in the URL based on the analysis of the HTTP header; and
receive the HTTP response to the HTTP request from the cloud-based microservice that processed the HTTP request.

20. The computer program product of claim 18, wherein the program instructions further cause the computer to:
determine whether resource utilization by previously deployed in-browser containers is greater than or equal to a maximum resource utilization threshold level in response to determining that the metadata corresponding to the in-browser container providing the in-browser microservice is present in the HTTP header of the HTTP response received from the server hosted at the domain contained in the URL based on the analysis of the HTTP header;
download the in-browser container providing the in-browser microservice corresponding to the web application from a container registry based on the metadata corresponding to the in-browser container present in the HTTP header of the HTTP response received from the server hosted at the domain contained in the URL in response to determining that the resource utilization by the previously deployed in-browser containers is not greater than or equal to the maximum resource utilization threshold level; and
deploy the in-browser container providing the in-browser microservice corresponding to the web application in the in-browser container execution engine within the web browser.
